(19) United States
(12) Patent Application Publication
(10) Pub. No.: US 2006/0092656 A1
(43) Pub. Date: May 4, 2006

(54) Afterburner taillight Systems

(75) Inventors: William Marcott Bassett, Gilroy, CA (US); Bill Bassett, Gilroy, CA (US)

Correspondence Address: BASSETT ENGINEERING, 5195 REDWOOD RETREAT ROAD, GILROY, CA, 95020, US

(73) Assignees: Mr. Bill Bassett, Gilroy, CA (US); BASSETT ENGINEERING, Gilroy, CA (US)

(21) Appl. No.: 10/904,180

(22) Filed: Oct. 28, 2004

(51) Int. Cl. B60Q 1/26

(52) U.S. Cl. 362/540

(57) ABSTRACT

The afterburner taillight systems are the ultimate solution for taillight, turn signal and running light placement and can be used on any motor vehicle that has exposed shock absorbers such as motorcycles, cars, trucks, etc. Solid Billet or Extruded materials in various Designs: Steel or Aluminum, many plastics. Shape, design concept and usage. With numerous applications and design features, it's designed to slide over and/or clamp to existing shock absorbers. In Addition this design can be used to slip over front fork assemblies or incorporated into the fork design. It can be in many shapes and sizes but its primary function is to use the shock absorber as its mounting feature.

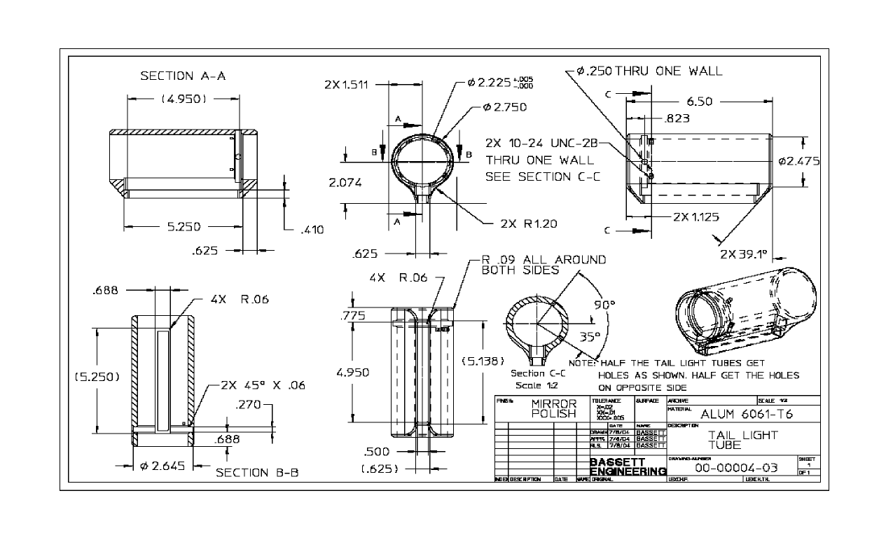

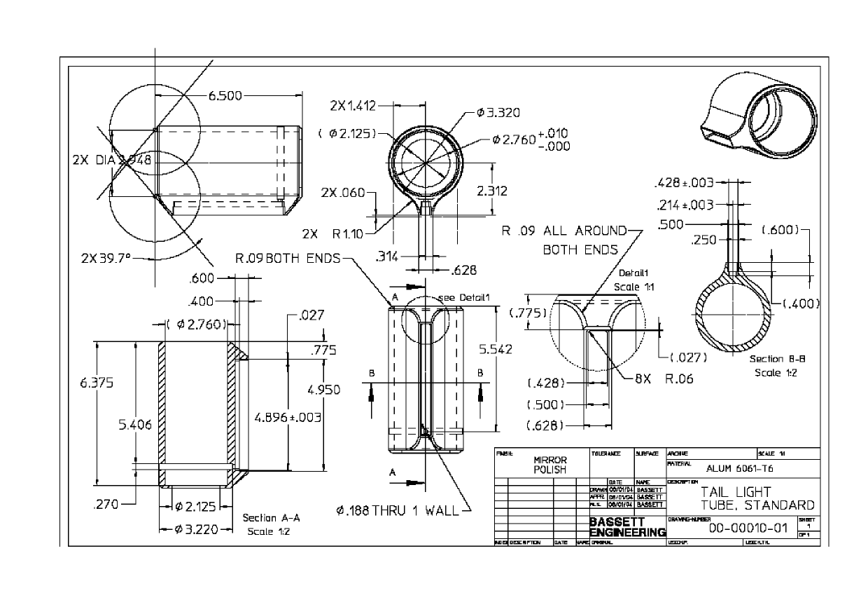

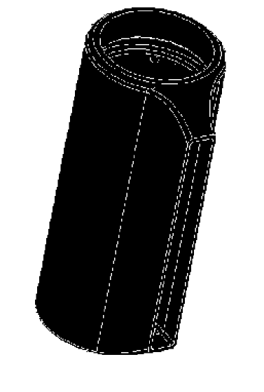

### DESCRIPTION

Afterburner taillight systems are slip sleeves designed to fit over shocks and/or in side bags or other areas on a motor vehicle. This product is a taillight, brake like, turn signal and/or running light on motor vehicles. It's designed to slide over and/or clamp to existing shock absorbers. It can be in many shapes and sizes but its primary function is to use the shock absorber as its mounting feature.

What is claimed is:

1. Bassett Engineering is claiming concept, usage, design and functionality.

2. Sizes and variations: There are various sizes and shapes of this product to fit the different size shock absorbers available.

3. Also usage and design to slip over the front forks or included in the front forks assemblies.

4. Other variations of this product include: Tubular design or two piece clamp design.

5. Lighting is LEDs in varying degrees and intensity or other bulb type styles.
